(19) United States
(12) Patent Application Publication
(10) Pub. No.: US 2017/0212238 A1
(43) Pub. Date: Jul. 27, 2017

(54) Remote Sensing of an Object's Direction of Lateral Motion Using Phase Difference Based Orbital Angular Momentum Spectroscopy

(71) Applicant: NEC Laboratories America, Inc., Princeton, NJ (US)

(72) Inventor: Giovanni Milione, Franklin Square, NY (US)

(21) Appl. No.: 15/385,961

(22) Filed: Dec. 21, 2016

Related U.S. Application Data
(60) Provisional application No. 62/286,034, filed on Jan. 22, 2016.

(51) Int. Cl. G01S 17/58; G01S 17/66

(52) U.S. Cl. CPC G01S 17/58; G01S 17/66

(57) ABSTRACT

A system for sensing a remote object includes a light beam for illuminating the remote object; a sensor to determine an orbital angular momentum (OAM) of the light beam; and a processor with code to determine the remote object's direction of lateral motion.

### BACKGROUND

The present invention is related to remote sensing of an object's direction of lateral motion using phase difference based optical orbital angular momentum spectroscopy.

In remote sensing with light, an object is interrogated with (illuminated by) a light beam and information about the object is obtained by analyzing the scattered light. Scattered light includes light that is completely or partially reflected from the object, and light that is completely or partially transmitted through the object.

Of particular importance is remote sensing of an object's direction of lateral motion (motion in a plane perpendicular to the light beam). This enables functionalities, such as, navigation (“is an object moving right-to-left or, left-to-right?”) and gesture recognition (“Did I move my hand up-to-down or, down-to-up?”). Remotely sensing an object's direction lateral motion is fundamental to many future technologies including, autonomous vehicles, interactive gaming, and smart homes.

FIGS. 1A-1C show exemplary detection of a lateral motion of a remote object with light using (a) Camera-based object tracking (b) Laser Doppler velocimetry (c) light's orbital angular momentum (OAM). The remote object moves with a lateral velocity v. The light beam has a frequency f.

One approach is Camera-based object tracking (FIG. 1A)—A high-resolution pixelated camera continuously captures images of a laterally moving remote object. The remote object's direction of lateral motion is “tracked” (sensed) by comparatively analyzing subsequent images. While effective, the computational intensiveness of camera-based object tracking is directly related to the number of pixels comprising the images. This is because the pixels must be analyzed to determine a change in subsequent images and in turn the remote object's direction of lateral motion.

For example, “background subtraction” is one of the simplest types of camera-based object tracking. In background subtraction, a pre-defined background image is subtracted from captured images. The difference between the captured images and the background image can infer the remote object's lateral motion. However, even in this simple example, to sense the lateral motion of a remote object, such as, a hand 1 meter from a camera, the camera must have a minimum 1024×720 pixel resolution comprising 737,280 pixels. Camera-base object tracking includes technologies, such as, Kinect, and speckle sensing.

Another approach is Laser Doppler velocimetry (FIG. 1B) where one or multiple laser beams of the same or different frequency interrogate (illuminate) a laterally moving remote object. The remote object's direction of lateral motion is sensed by analyzing the resulting frequency shift of the scattered light by one or multiple detectors. The object's direction of lateral motion is directly related to the frequency shift of the scattered light. While effective, laser Doppler velocimetry requires sensitive frequency measurements which in turn require costly and complex opto-electronic detection methods, such as, heterodyne-based coherent detection.

### SUMMARY

In one aspect, a system for sensing a remote object includes a light beam for illuminating the remote object; a sensor to determine the orbital angular momentum (OAM) of the light beam; and a processor with code to determine the remote object's direction of lateral motion.

Advantages of the system may include one or more of the following. The preferred embodiment is less computationally intensive than camera-based object tracking. For example, when using “background subtraction,” to sense the direction of lateral motion of a remote object, such as, a hand 1 meter from a camera, the camera must have a minimum 1024×720 pixel resolution comprising 737,280 pixels. In the preferred embodiment, a remote object's direction of lateral motion can be sensed by analyzing light's OAM. This requires a minimum of the equivalent of 4 pixels. Therefore, the preferred embodiment will be less computationally intensive than camera-based object tracking. As the preferred embodiment is less computationally intensive, the preferred embodiment will also have faster operation. The preferred embodiment does not require the sensitive frequency measurements of laser Doppler velocimetry. In the preferred embodiment, a remote object's direction of lateral motion can be sensed by analyzing light's OAM. This does not require sensitive frequency measurements which in turn require costly and complex opto-electronic detection methods, such as, heterodyne-based coherent detection.Light's OAM can be analyzed at a single frequency. As the preferred embodiment does not require sensitive frequency measurements, it is less complex and costly.

### BRIEF DESCRIPTION OF THE DRAWINGS

FIGS. 1A-1C show various conventional methods to detect lateral motion of an object.

FIG. 2 shows an exemplary block diagram of a system to sense the direction of lateral motion of a remote object.

FIG. 3 shows in more details block 400 of FIG. 2.

FIG. 4 shows in more details block 700 of FIG. 2.

FIG. 5 shows in more details block 800 of FIG. 2.

FIG. 6 shows another exemplary system to sense the direction of lateral motion of a remote object.

FIG. 7 shows an exemplary computing system in FIG. 1.

### DESCRIPTION

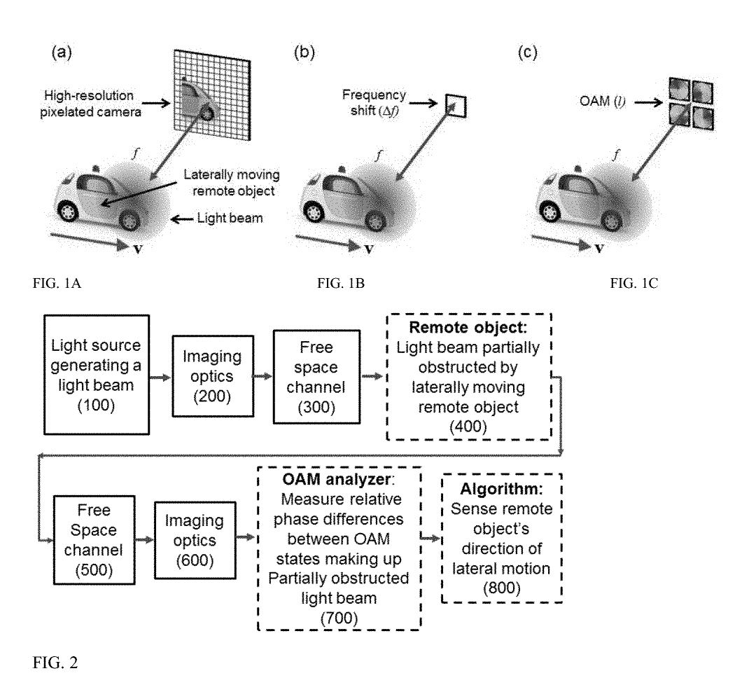

A method is disclosed to remotely sense a remote object's direction of lateral motion with light. This method has less computational intensiveness than camera-based object tracking, and does not require the sensitive frequency measurements of laser Doppler velocimetry. In the preferred embodiment (FIG. 1c):

1. The laterally moving remote object is interrogated with (illuminated by) a light beam.

2. The light beam is partially obstructed by the laterally moving remote object.

3. The partially obstructed light beam is described as a superposition of light's orbital angular momentum (OAM) states.

4. The remote object's direction of lateral motion is directly related to the relative phase differences between the OAM states.

5. The OAM of the partially obstructed light beam is analyzed:
a. The phase differences between the OAM states are measured.
b. The remote object's direction of lateral motion is determined from the phase differences.

As compared to camera-based object tracking, the preferred embodiment has less computational intensiveness. A minimum of 4 effective pixels are required to analyze the phase difference between OAM states. Compared to laser Doppler velocimetry, the preferred embodiment does not require sensitive frequency measurements. The phase difference between OAM states can be analyzed at a single frequency.

FIG. 2 shows a block diagram of the key modules of the preferred embodiment:

(100) A light source is used to generate a light beam. The light source can be a laser etc. The light beam can be the fundamental spatial mode (Gaussian) of a laser, a higher-order spatial mode, or a superposition of spatial modes.

(200) Imaging optics are used to make the light beam propagate over a free space channel (300) and illuminate a laterally moving remote object (400). The imaging optics can be a lens, a combination of lenses, diffractive optical element, etc. apertures etc.

(300) The free space channel can be the Earth's atmosphere, outer-space, inside a building, between land, sea, air, or space vehicles and their surroundings or other land, sea, air, or space vehicles.

(400) The laterally moving remote object can be a permanent structure, such as, a buildings etc., natural terrain, such as rocks, mountains, hills, etc., land, sea, air, or space vehicles, etc., people, animals, etc.

Lateral motion is defined as motion perpendicular to the light beam's predominant direction of propagation. The remote object's direction of lateral motion will be described in more detail below. When the light beam illuminates the remote object (400), the light beam is partially obstructed by the remote object. In general, a partially obstructed light beam can be described as a superposition of light's OAM states. The amplitudes and relative phases of each OAM state making up the partially obstructed light beam depend on the lateral motion of the remote object. Light's OAM states will be described in more detail below. Then, the light beam, partially obstructed by the remote object, propagates over another free space channel (500).

(500) The free space channel can be the Earth's atmosphere, outer-space, inside a building, between land, sea, air, or space vehicles and their surroundings or other land, sea, air, or space vehicles.

This free space channel can be the same free space channel as (300) (reflection/back-scattering) or a different free space channel (transmission/forward-scattering).

(600) Imaging optics are used to collect the light beam that is partially obstructed by the remote object (400). The imaging optics can be the same imaging optics as (200) (reflection/back-scattering) or different imaging optics (transmission/forward-scattering). The imaging optics can be a lens, a combination of lenses, diffractive optical element, etc. apertures etc.

(700) The OAM of the partially obstructed light beam is analyzed by an OAM analyzer. In general, a partially obstructed light beam can be described as a superposition of light's OAM states. The amplitudes and relative phases of each OAM state making up the partially obstructed light beam depend on the lateral motion of the remote object. Light's OAM states will be described in more detail below. The relative phase differences between the OAM states are analyzed. The remote object's direction of lateral motion is directly related to the relative phase differences between the OAM states. The OAM analyzer can be a liquid crystal on silicon spatial light modulator, another liquid crystal based device, a diffractive optical element, an integrated silicon device, an optical fiber, a refractive optical element made up of glass or plastic, a wave front sensor, a polarization analyzer, such as, a polarimeter, an interferometer, etc. The OAM analyzer will be described in more detail below.

(800) A process senses the direction of lateral motion of the remote object, and takes as input the relative phase measurements described above. The process is described in more detail below.

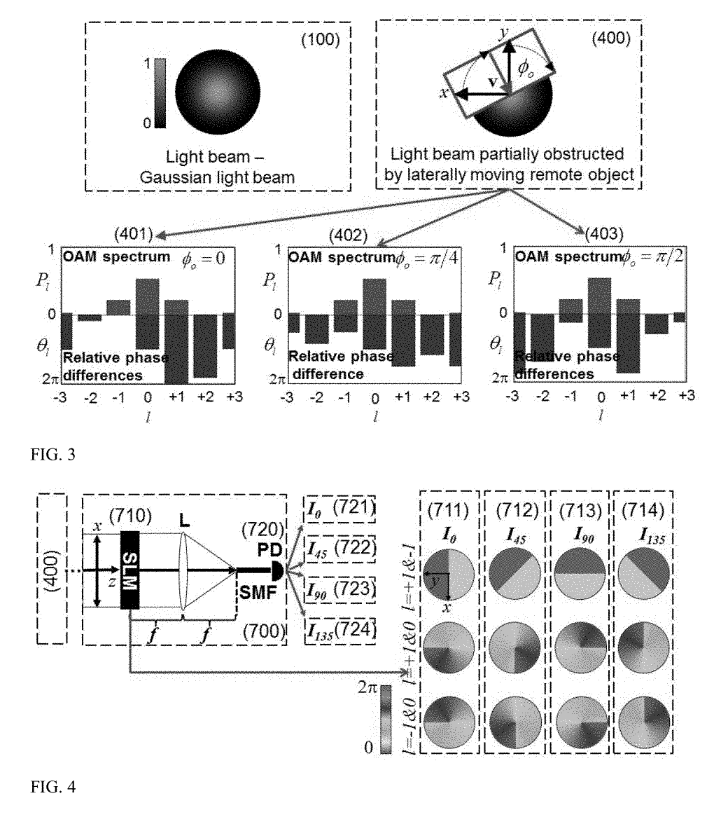

FIG. 3 shows in more details Block (400) which represents a light beam being partially obstructed by the laterally moving remote object. Lateral motion is defined as motion perpendicular to the light beam's predominant direction of propagation. Consider the light beam being a Gaussian light beam that propagates along the z-direction (FIG. 2(a)) (100). The remote object moves laterally, i.e., in the x-y plane. (x,y,z) are Cartesian coordinates. The direction of lateral motion of the remote object is described by the vector:

v=vₓx+v_{y}y 1)

where v_{y} and vₓ are the object's velocity in the x- and y-directions (lateral velocity), respectively, and x and y are unit vectors in the x-y plane. The direction of v in the x-y plane is described by the angle:

φ₀=arctan(v_{y}/vₓ). 2)

The light beam, partially obstructed by the laterally moving remote object, is shown in FIG. 2(b). The size of the object can be considered to be much larger than the size of the light beam. The size of the light beam can be described via its waist size. If the light beam is a Gaussian light beam, i.e., its amplitude as a function of distance from the cent er of the light beams is described by a Gaussian function, the light beam's waist size is the distance from the center of the light beam such that the amplitude of the light beam is 1/e times less than the amplitude at the center where e is the natural exponential (e˜2.718). In this case, the light beam can be approximated as a hard edge obstruction. A hard edge obstruction is an obstruction of the light beam such that a smooth/uniform/straight edge is created between the obstructed portion of the light beam and the unobstructed portion of the light beam. However, the size of the object can also be comparable to the size of the light beam's waist or it can be smaller than the light beam's waste. Effectively, the partially obstructed light beam is an image whose rotational orientation in the x-y plane is described by φₒ.

Block (400) describes a light beam being partially obstructed by a laterally moving remote object. The partially obstructed light beam is made up of a superposition of light's orbital angular momentum (OAM) states.

An OAM state is a light field that has an azimuthally varying phase given by exp(ilφ). An OAM state has an OAM of lh/2π per photon (l=. . . −2, −1, 0, +1, +2, . . . ) where (r,φ) are cylindrical coordinates and h is Planck's constant. Note that cylindrical coordinates are related to Cartesian coordinates by r²=x²+y² and φ=arctan(y/x).

In general, the electric field of a partially obstructed light beam can be described as a superposition of OAM states, which is given by the equation:

E(r,φ)=Σcₗ(r)exp(ilφ), 3)

where cₗ(r) are the complex coefficients of the OAM states in the superposition, the summation being over all l. The powers of the OAM states comprising the partially obstructed light beam are given by:

Pₗ=∫rdr|cₗ(r)|² 4)

the integral being over all r. The relative phase differences between the OAM states are given by the equation:

θₗ=angle(cₗ(r)), 5)

The spectrum of powers is referred to as the light beam's OAM spectrum. Theoretically calculated and normalized OAM spectra and relative phase differences between the OAM states making up the partially obstructed light beam (half the light beam is obstructed) are shown in (401), (402), and (403), respectively, for three different directions of lateral motion φₒ, φₒ₌0, φₒ=π/4, and φₒ=π/2. The majority of power of the OAM spectra is in the l=−1, l=0, and l=+1 OAM states.The OAM spectra does not depend on the object's direction of lateral motion φₒ, i.e., the OAM spectra are the same for each value of φₒ. However, as can be seen, the relative phase differences between the OAM states depend on the remote object's direction of lateral motion φₒ, i.e., the relative phase differences between the OAM states are different for each value of φₒ.

FIG. 4 shows a detailed description of block (700) for an OAM analyzer that can measure the relative phase differences between OAM states. Block (700) represents an OAM analyzer that can measure the relative phase differences between OAM states. An example of an OAM analyzer is shown where a partially obstructed light beam is imaged onto a liquid on crystal spatial light modulator (SLM) (710). The SLM displays “phase masks” as described below. The phase maske modulates the partially obstructed light beam. Modulation means that the spatially dependent phase and/or amplitude of the partially obstructed light beam is changed in a way that corresponds to the phase mask. A lens (L), placed one focal length (f) away from the SLM, focuses the partially obstructed light beam that is modulated by the phase mask into a single mode optical fiber (SMF). The power of the light that is focused into the SMF is measured by a photo-diode (PD).

The SLM sequentially or simultaneously displays four phase masks on its screen. The phase masks correspond to four superpositions of two OAM states. When each phase mask is displayed, the intensity that is measured by the PD is given by Iₒ(721), I₄₅(722), I₉₀(723), and I₁₃₅(724). Phase masks used to measure Iₒ, I₄₅, I₉₀, and I₁₃₅ correspond to the relative phase differences between l=+1 & −1, l=+1 & 0, and l=−1 & 0 OAM states and are shown in (711), (712), (713) and (714), respectively.

As shown, one photodiode is used. However, one photodiode for each intensity measurement (721), (722), (723), and (724) can also be used. As shown, an SLM displaying phase masks is used. However, any device that can make an equivalent measurement can be used. This includes, another liquid crystal based device, a diffractive optical element, an integrated silicon device, an optical fiber, a refractive optical element made up of glass or plastic, a wave front sensor, a polarization analyzer, such as, a polarimeter, an interferometer, etc.

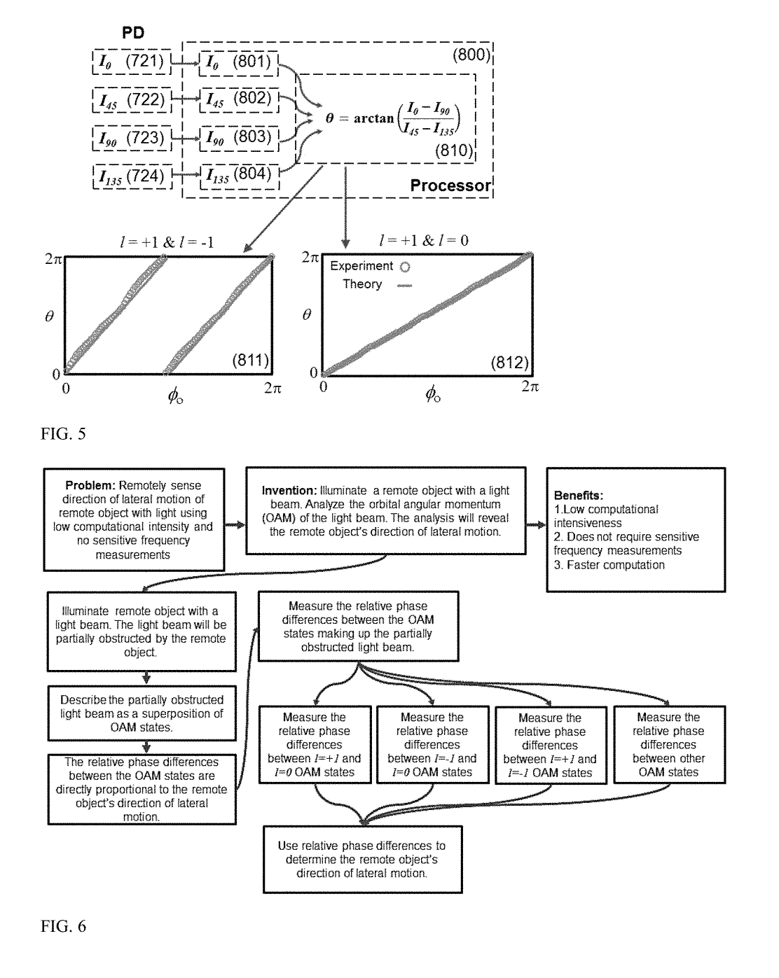

Block (800) is described in more detail in FIG. 5. Block (800) represents a process to sense the direction of lateral motion of a remote object using the measurements made by the OAM analyzer (700). The intensity measurements (721), (722), (723), and (724) are input to a processor. The processor can be a CPU, electronics, etc. The four intensity measurements are converted into electrical or digital signals (801), (802), (803), and (804). Using the signals, the relative phase difference between the OAM states are calculated according to the equation (810):

$$θ = arctan ( \frac{{I}_{0} - {I}_{90}}{{I}_{45} - {I}_{135}} ) . \qquad 6 )$$

Experimentally measured and theoretically calculated values of the relative phase difference θ as a function of a remote object's direction of lateral motion φₒ are shown in FIG. 5 for l=+1 & −1 (811) and l=+1 & 0 (812) states. As can be seen, φₒ is linearly dependent on θ. Therefore, the direction of lateral motion of the remote object φₒ can be sensed using this process.

The remote object's direction of lateral motion is directly related to the relative phase differences between the OAM states making up a light beam that is partially obstructed by the remote object.

In previous work, the powers of the OAM states making up a light beam partially obstructed by a remote object were analyzed to imply the shape of the remote object [13]. However, the phases of the OAM states were not analyzed and the remote object's direction of lateral motion was not analyzed.

Also, the lateral motion of a remote object was sensed with light by analyzing the powers of the OAM states making up a light beam that was partially obstructed by the remote object. However, the phases of the OAM states were not analyzed and the OAM analyzer had to be “tilted.”

In the preferred embodiment:
1. The partially obstructed light beam is described as a superposition of light's orbital angular momentum (OAM) states.
2. The remote object's direction of lateral motion is directly related to the relative phase differences between the OAM states.
3. The OAM of the partially obstructed light beam is analyzed:
a. The phase differences between the OAM states are measured.
b. The remote object's direction of lateral motion is determined from the phase differences.

As compared to camera-based object tracking, the preferred embodiment has less computational intensiveness. A minimum of 4 effective pixels ae required to analyze the phase difference between OAM states. As compared to laser Doppler velocimetry, the preferred embodiment does not require sensitive frequency measurements. The phase difference between OAM states can be analyzed at a single frequency.

The preferred embodiment is less computationally intensive than camera-based object tracking. For example, when using “background subtraction,” to sense the direction of lateral motion of a remote object, such as, a hand 1 meter from a camera, the camera must have a minimum 1024×720 pixel resolution comprising 737,280 pixels. In the preferred embodiment, a remote object's direction of lateral motion can be sensed by analyzing light's OAM. This requires a minimum of the equivalent of 4 pixels. Therefore, the preferred embodiment will be less computationally intensive than camera-based object tracking. As the preferred embodiment is less computationally intensive, the preferred embodiment will also have faster operation.

The preferred embodiment does not require the sensitive frequency measurements of laser Doppler velocimetry. In the preferred embodiment, a remote object's direction of lateral motion can be sensed by analyzing light's OAM. This does not require sensitive frequency measurements. Light's OAM can be analyzed at a single frequency. As the preferred embodiment does not require sensitive frequency measurements, it is less complex.

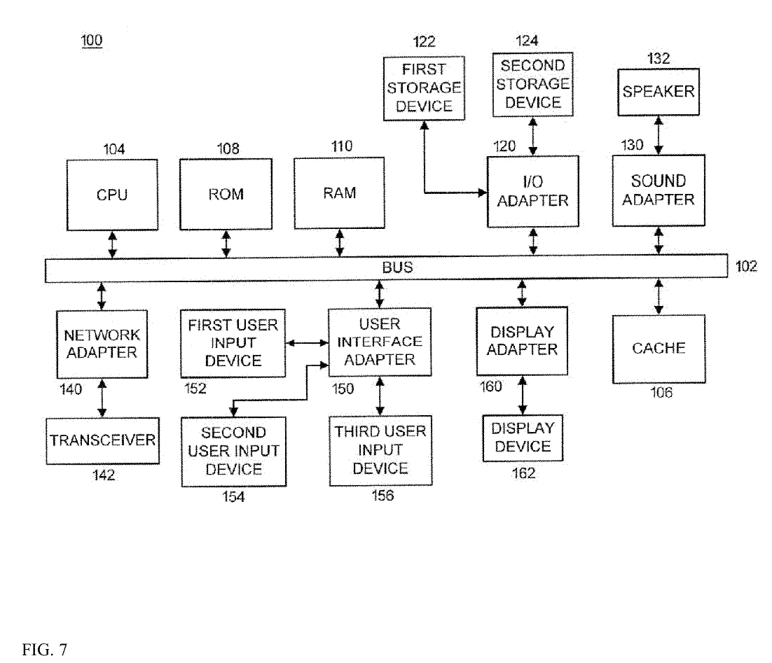

Referring to the drawings in which like numerals represent the same or similar elements and initially to FIG. 7, a block diagram describing an exemplary processing system 100 to which the present principles may be applied is shown, according to an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to a system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to the system bus 102 by the sound adapter 130. A transceiver 142 is operatively coupled to the system bus 102 by a network adapter 140. A display device 162 is operatively coupled to the system bus 102 by a display adapter 160. A first user input device 152, a second user input device 154, and a third user input device 156 are operatively coupled to the system bus 102 by a user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used while maintaining the spirit of the present principles. The user input devices 152, 154, and 156 can be the same type of user input device or different types of user input devices. The user input devices 152, 154, and 156 are used to input and output information to and from the system 100.

Of course, the processing system 100 may also include other elements (not shown), as readily contemplated by one of skill in the art, as well as omit certain elements. For example, various other input devices and/or output devices can be included in the processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations, can also be utilized as readily appreciated by one of ordinary skill in the art. These and other variations of the processing system 100 are readily contemplated by one of ordinary skill in the art given the teachings of the present principles provided herein.

It should be understood that embodiments described herein may be entirely hardware, or may include both hardware and software elements which includes, but is not limited to, firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor, e.g., a hardware processor, coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method for sensing a remote object, comprising illuminating the remote object with a light beam;
determining an orbital angular momentum (OAM) of the light beam; and
determining the remote object's direction of lateral motion.

2. The method of claim 1, wherein the remote object comprises a vehicle, car or moving object.

3. The method of claim 2, wherein the light beam is partially obstructed by the remote object.

4. The method of claim 3, comprising determining the partially obstructed light beam as a super position of orbital angular momentum (OAM) states.

5. The method of claim 4, comprising determining relative phase differences between OAM states as proportional to the remote object's direction of lateral motion.

6. The method of claim 5, comprising measuring the relative phase differences between the OAM states making up the partially obstructed light beam.

7. The method of claim 6, comprising measuring relative phase differences between l=1 and l=0 OAM states.

8. The method of claim 6, comprising measuring relative phase differences between l=−1 and l=0 OAM states.

9. The method of claim 6, comprising measuring relative phase differences between l=1 and l=1 OAM states.

10. The method of claim 6, comprising measuring relative phase differences between OAM states.

11. The method of claim 1, comprising using relative phase differences to determine the remote object's direction of lateral motion.

12. The method of claim 1, comprising determining an electric field of a partially obstructed light beam as a superposition of OAM states:
E(r,φ)=Σcₗ(r)exp(ilφ),
where cₗ(r) are the complex coefficients of the OAM states in the superposition, the summation being over all l and l is a positive or negative integer.

13. The method of claim 12, comprising determining relative phase differences between the OAM states as:
θₗ=angle(cₗ(r)).

14. The method of claim 1, comprising determining the OAM of the partially obstructed light beam.

15. The method of claim 1, wherein phase differences between the OAM states are measured and remote object's direction of lateral motion is determined from the phase differences.

16. The method of claim 1, comprising imaging a partially obstructed light beam onto a liquid on crystal spatial light modulator (SLM).

17. The method of claim 1, wherein the SLM sequentially or simultaneously displays four phase masks on a screen.

18. The method of claim 17, wherein the phase masks correspond to four superpositions of two OAM states and, measuring an intensity as Iₒ, I₄₅, I₉₀, and I₁₃₅ when each phase mask is displayed.

19. The method of claim 1, comprising determining a relative phase difference between the OAM states as:
$$θ = arctan ( \frac{{I}_{0} - {I}_{90}}{{I}_{45} - {I}_{135}} ) .$$

20. A vehicular system for sensing a remote object, comprising:
a vehicle;
a light beam mounted on the vehicle for illuminating the remote object;
a sensor to determine an orbital angular momentum (OAM) of the light beam; and
a processor with code to determine the remote object's direction of lateral motion.
